(19) United States
(12) Patent Application Publication
(10) Pub. No.: US 2024/0013231 A1
(43) Pub. Date: Jan. 11, 2024

(54) SYSTEM AND METHOD FOR DATA VALIDATION RULE SIMULATION

(71) Applicant: SAP SE, Walldorf (DE)

(72) Inventors: Kefeng WANG, Wiesloch (DE); Marcus GALLECK, Oftersheim (DE)

(21) Appl. No.: 17/859,420

(22) Filed: Jul. 7, 2022

(51) Int. Cl. G06Q 30/00; G06F 11/34

(52) U.S. Cl. CPC G06Q 30/018; G06F 11/3457

(57) ABSTRACT

A data repository may contain electronic records, each electronic record including a record identifier and a set of record characteristics. A data validation rule data store may contain at least one active data validation rule. A data validation server may access the active data validation rule from the data validation rule data store. The server receives an adjustment to the active data validation rule from a user to create an inactive data validation rule. The server may also receive at least one filter condition defining a subset of the electronic records in the data repository. The server can then automatically simulate execution of the active data validation rule on record characteristics of the subset to obtain an active result and automatically simulate execution of the inactive data validation rule to obtain an inactive result. The system then displays the active result and the inactive result to the user.

### BACKGROUND

An enterprise may store a substantial amount of information. For example, a business might store information about customers, purchase orders, human resources, financial data, etc. The enterprise may use Master Data Management (“MDM”) techniques to ensure the uniformity, accuracy, stewardship, semantic consistency, and accountability of the data. A data validation rule may be a part of that process and act as a gatekeeper to make sure that data are entered into the system in good quality manner and help track the current status of data quality. Note that an enterprise environment may frequently change which can cause challenges and problems requiring continuous updates to existing data validation rules. In some cases, an enterprise may use a simulation designed to verify whether a rule change meets expectations before it is put into production usage. However, such simulations may not clearly indicate the consequences of a rule change, making decisions about implementing rule changes difficult.

It would therefore be desirable to perform data validation for an enterprise in an improved, efficient, and accurate manner.

### SUMMARY

A data repository may contain electronic records, each electronic record including a record identifier and a set of record characteristics. A data validation rule data store may contain at least one active data validation rule. A data validation server may access the active data validation rule from the data validation rule data store. The server receives an adjustment to the active data validation rule from a user to create an inactive data validation rule. The server may also receive at least one filter condition defining a subset of the electronic records in the data repository. The server can then automatically simulate execution of the active data validation rule on record characteristics of the subset to obtain an active result and automatically simulate execution of the inactive data validation rule to obtain an inactive result. The system then displays the active result and the inactive result to the user.

Some embodiments comprise: means for accessing, by a computer processor of a data validation server, an active data validation rule from a data validation rule data store; means for receiving, from a user via a user interface, an adjustment to the active data validation rule to create an inactive data validation rule; means for receiving, from the user via the user interface, at least one filter condition defining a subset of the electronic records in a data repository, wherein the data repository contains electronic records, each electronic record including a record identifier and a set of record characteristics; means for automatically simulating execution of the active data validation rule on record characteristics of the subset of the electronic records in the data repository to obtain an active result; means for automatically simulating execution of the inactive data validation rule on record characteristics of the subset of the electronic records in the data repository to obtain an inactive result; and means for arranging for the active result and the inactive result to be displayed to the user.

Some technical advantages of some embodiments disclosed herein are improved systems and methods to perform data validation for an enterprise in an improved, efficient, and accurate manner.

### BRIEF DESCRIPTION OF THE DRAWINGS

FIG. 1 is a high-level architecture for a system in accordance with some embodiments.

FIG. 2 illustrates a method according to some embodiments.

FIG. 3 is a data validation environment in accordance with some embodiments.

FIG. 4 is a data validation new simulation data selection display according to some embodiments.

FIG. 5 is a data validation new active simulation display in accordance with some embodiments.

FIG. 6 is a data validation new inactive simulation display according to some embodiments.

FIG. 7 is a simulation and quality preview display in accordance with some embodiments.

FIG. 8 is an apparatus or platform according to some embodiments.

FIG. 9 illustrates a data validation database in accordance with some embodiments.

FIG. 10 is a human machine interface display in accordance with some embodiments.

FIG. 11 illustrates a handheld tablet computer according to some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components, and circuits have not been described in detail so as not to obscure the embodiments.

One or more specific embodiments of the present invention will now be described. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

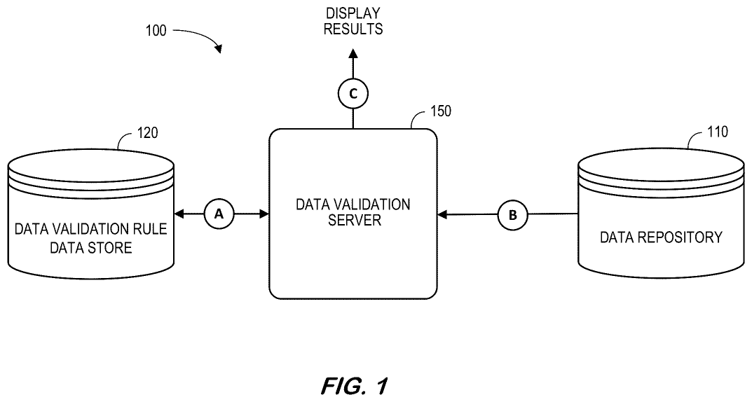

Some embodiments described herein provide a quality preview of data validation rule changes in substantially real-time and may notify corresponding managers about potential impacts to data quality. Furthermore, embodiments may automate the quality preview whenever rules are changed. FIG. 1 is a high-level block diagram of a system 100 according to some embodiments. A data repository 110 may store electronic records, each electronic record including a record identifier and a set of record characteristics. The electronic records might be associated with, for example, items in which case the record characteristics might comprise an item size, an item weight, an item price, etc. A data validation rule data store 120 contains at least one active data validation rule. The data validation rule might comprise, for example a business rule stating that a shipping weight should be approximately equal to an item weight plus a packaging weight. This can be used, for example, to help ensure that the information in the data repository 110 is valid (that is, if the item weight is in kilograms and the package weight is in pounds, the rule would detect a problem). The rule may be “active,” for example, when it is currently being used to provide validation in a production environment for an enterprise. As used herein, the phrase “production environment” may refer to a setting where software and other products are actually put into operation for their intended uses by end users.

At (A), a data validation server 150 accesses the active data validation rule from the data validation rule data store. The data validation server 150 may also receive, from a user via a user interface, an adjustment to the active data validation rule to create an inactive data validation rule. The data validation server 150 may also receive, from the user via the user interface, at least one filter condition defining a subset of the electronic records in the data repository 110. For example, the user might select the data representing all items produced at a certain manufacturing plant during a certain time period.

At (B), the data validation server 150 may retrieve the subset of electronic records from the data repository 110 and automatically simulate execution of the active data validation rule on record characteristics of the subset to obtain an “active” result. A used herein, the term “automatically” may refer to a device or process that can operate with little or no human interaction. Similarly, the data validation server 150 may automatically simulate execution of the inactive data validation rule on record characteristics of the subset of the electronic records in the data repository 110 to obtain an “inactive” result. At (C), the data validation server 150 may arrange for the active result and the inactive result to be displayed to the user. This might help a data steward, for example, determine if the adjustment to the active data validation rule improved or degraded the quality of the enterprise data.

According to some embodiments, devices, including those associated with the system 100 and any other device described herein, may exchange data via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The elements of the system 100 may store data into and/or retrieve data from various data stores (e.g., the data repository 110 and the data validation rule data store 120), which may be locally stored or reside remote from the data validation server 150. Although a single data validation server 150 is shown in FIG. 1, any number of such devices may be included. Moreover, various devices described herein might be combined according to embodiments of the present invention. For example, in some embodiments, the data validation server 150 and the data repository 110 might comprise a single apparatus. Some or all of the system 100 functions may be performed by a constellation of networked apparatuses, such as in a distributed processing or cloud-based architecture.

An operator (e.g., a database administrator) may access the system 100 via a remote device (e.g., a Personal Computer (“PC”), tablet, or smartphone) to view data about and/or manage operational data in accordance with any of the embodiments described herein. In some cases, an interactive graphical user interface display may let an operator or administrator define and/or adjust certain parameters (e.g., to set up or adjust various mapping relationships) and/or provide or receive automatically generated recommendations, results, and/or alerts from the system 100. According to some embodiments, the operator may generate instructions to adjust data quality rules (e.g., pre-determined tolerances) or set thresholds that, when triggered, may manually or automatically result in an adjustment of data validation rules.

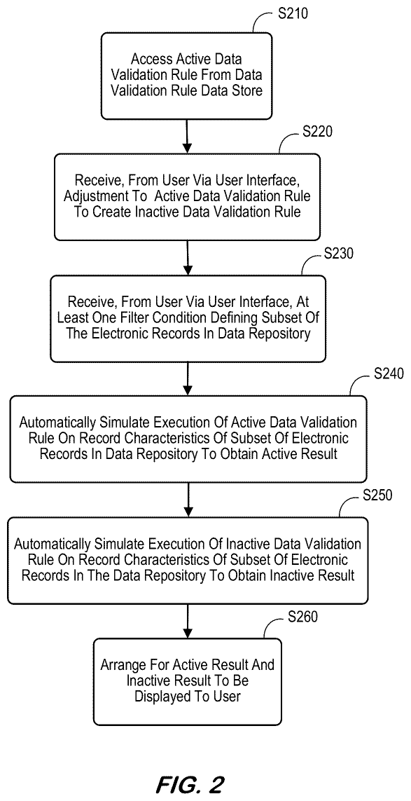

FIG. 2 illustrates a method to perform data validation for an enterprise in an improved, efficient, and accurate manner according to some embodiments. The flow charts described herein do not imply a fixed order to the steps, and embodiments of the present invention may be practiced in any order that is practicable. Note that any of the methods described herein may be performed by hardware, software, an automated script of commands, or any combination of these approaches. For example, a computer-readable storage medium may store thereon instructions that when executed by a machine result in performance according to any of the embodiments described herein.

At S210, a computer processor of a data validation server may access an active data validation rule from a data validation rule data store. The active data validation rule might indicate, for example, that an item price should approximately equal an item cost plus a profit margin. The rule might be “active” in that it is currently being used to validate enterprise information in a production environment. At S220, an adjustment to the active data validation rule may be received from a user (via a user interface) to create an inactive data validation rule. For example, the adjustment might indicate that an item price should approximately equal an item cost plus a profit margin plus a shipping cost. The rule might be “inactive” in that it is not currently being used to validate enterprise information.

At S230, at least one filter condition defining a subset of the electronic records in a data repository may be receiving from the user (via the user interface). The data repository may, for example, contain electronic records, each electronic record including a record identifier and a set of record characteristics. The filter condition might include, for example, an item identifier condition (e.g., all items having an identifier beginning with “X123 . . . ”, a location condition (e.g., all items manufactured in Europe), an item type condition (e.g., all items marked as “sold”), a date condition (e.g., all items manufactured in a particular month), etc. According to some embodiments, the data repository may be associated master data management, master data governance, a master data steward, etc.

At S240, the system may automatically simulate execution of the active data validation rule on record characteristics of the subset of the electronic records to obtain an active result. Similarly, at S250 the system may automatically simulate execution of the inactive data validation rule on record characteristics of the subset of the electronic records to obtain an inactive result. The active result and/or the inactive result might include, for example, an indication that an electronic record passed a validation rule, an indication that an electronic record did not pass a validation rule, an indication that a validation rule was not applied to an electronic record (e.g., an item associated with that record was not within the scope of the rule), a score calculated for a validation rule, etc.

The system may then arrange for the active result and the inactive result to be displayed to the user at S260. According to some embodiments, the display of the active result and the inactive result is provided graphically via the user interface. Moreover, selection of a portion of the graphic display may result in further details about the active result or inactive result being provided to the user.

According to some embodiments, the data validation server may further, responsive to an indication received from the user, replace logic of the active data validation rule with logic of the inactive data validation rule. That is, the adjusted rule will now be used to validate information in a production environment of the enterprise. Moreover, in some embodiments the data validation server is further to receive, from the user via the user interface, a further adjustment to the inactive data validation rule to create a new inactive data validation rule (e.g., a second revised version of the current active rule). The system can then automatically simulate execution of the new inactive data validation rule on the subset of the electronic records to obtain a new inactive result. According to some embodiments, the data validation server is further to automatically detect an anomaly in substantially real-time (e.g., when a validation score moves beyond a threshold value. The anomaly might be associated with, for example, a security anomaly (e.g., a potential cyber security problem in connection with the enterprise data), a regulatory compliance anomaly (e.g., a legal requirement to maintain certain records in accordance with a governmental regulation or statute), etc.

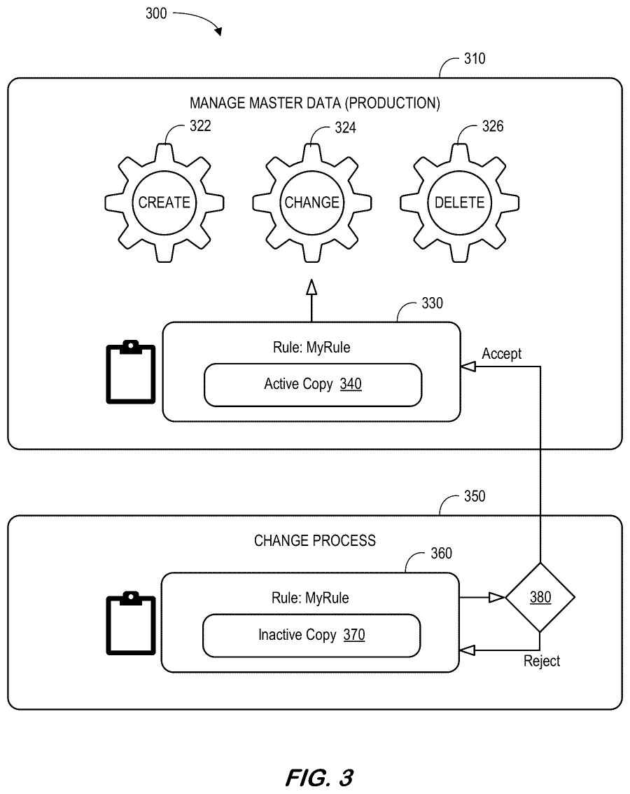

FIG. 3 is a data validation environment 300 in accordance with some embodiments. The data validation environment 300 includes a manage master data production platform 310, such by letting a data steward create 322, change 324, and/or delete 326 data. The data may be validated using one or more validation rules 330 (e.g., the “MyRule” active copy 340 which might comprise version 1.0 of a validation condition or logic). A change process 350 may include an inactive copy 370 of that rule 360 (e.g., version 1.1 of MyRule). After an evaluation 380 (e.g., a manual review by a data steward or an automatic analysis), the system may reject the inactive copy 370 or accept the inactive copy 370 which would then replace the existing active copy 340. In this way, a business rule may be implemented and activated in the manage master data production platform 310 and applied in a business process. Continuously, it is possible to change the rule in a copy or “inactive” version or copy 370. The changes can then be tested before it replaces the current productive version of the rule 340. The simulation used to test the rule may exactly provide a preview of the quality impact on the enterprise data.

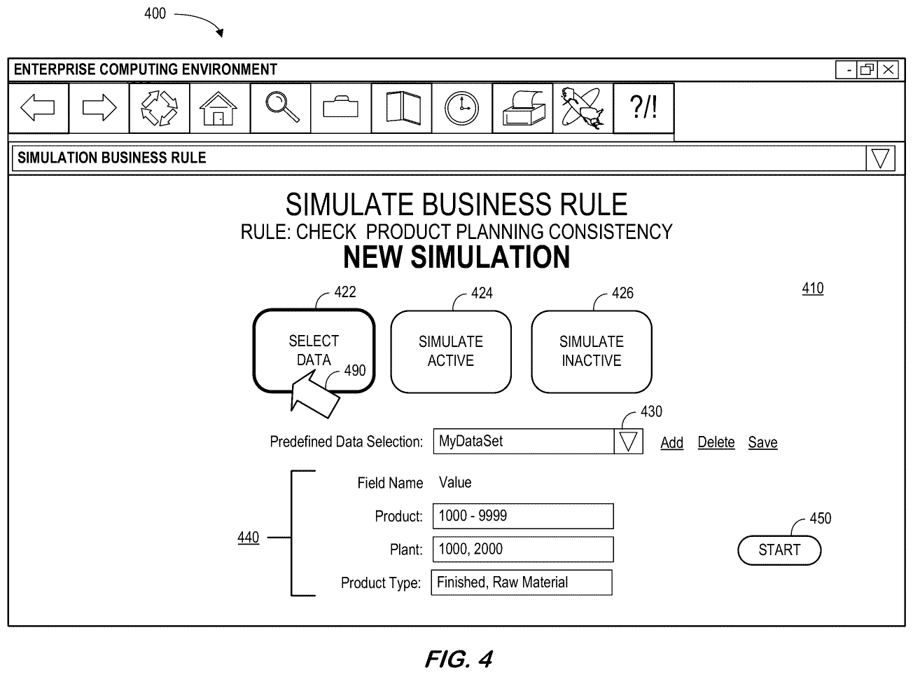

Some embodiments provide a user interface to simulate the rule and visualize the impact. For example, FIG. 4 is a data validation new simulation data selection display 400 according to some embodiments. The display 400 includes a user interface 410 that lets a user (e.g., a data steward) select data 422, simulate an active rule 424, or simulate an inactive rule 426 (e.g., by selecting those icons with a touchscreen or computer mouse pointer 490). The display 400 also lets the user select a particular business rule (e.g., “Check Product Planning Consistency”) to be simulated, a particular filter or “predefined data selection” name 430 (e.g., “MyDataSet), and one or more conditions for that filter (e.g., field name, product, plant, product type, etc.). The simulation can they apply both the active and inactive versions of the business rule to selected data set and present the results for comparison. In this way, the display 400 may define a data selection for the simulation such that data is coming from the current system and can define filters on data attributes. According to some embodiments, the data selection may be saved for the next the simulation is executed for the rule or for simulations to be executed for other business rules.

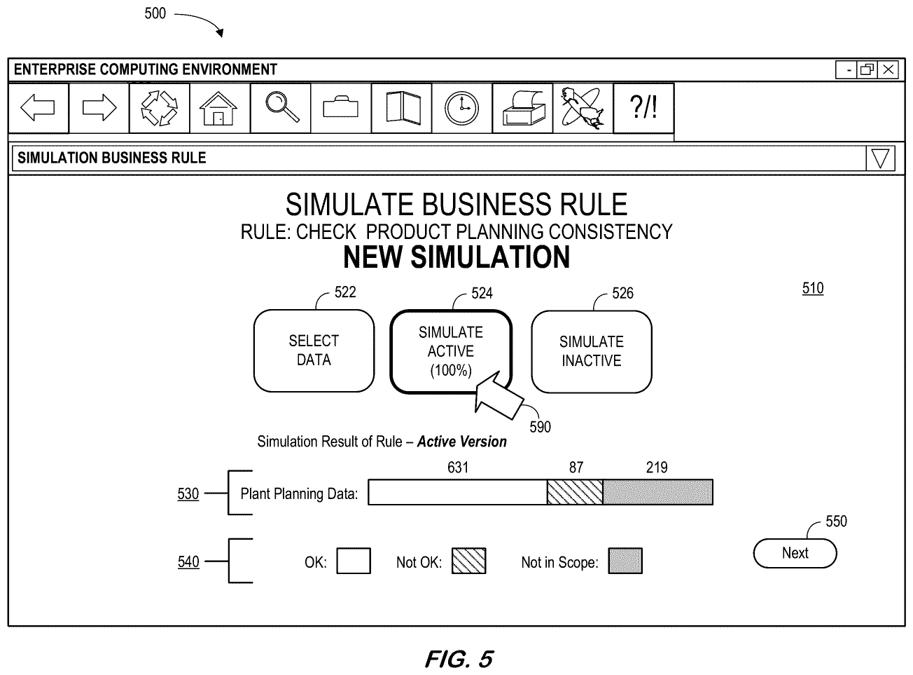

Selection of a “Start” icon 450 may initiate execution of the simulation (e.g., for the active version of the rule). FIG. 5 is a data validation new active simulation display 500 in accordance with some embodiments. As before, the display 500 includes a user interface 510 that lets a user (e.g., a data steward) select data 522, simulate an active rule 524, or simulate an inactive rule 526 (e.g., by selecting those icons with a touchscreen or computer mouse pointer 590). The display 500 also includes a graphical indication of simulation results 530 for the active business rule along with a key or legend 540 to help a user interpret the results (e.g., indicating that an electronic record passed a validation rule (“OK”), an indication that an electronic record did not pass a validation rule (“Not OK”), an indication that a validation rule was not applied to an electronic record (“Not in Scope”), etc.).

According to some embodiments, a user can select a portion of the simulation results 530 to obtain a “drill down” view of supporting data.

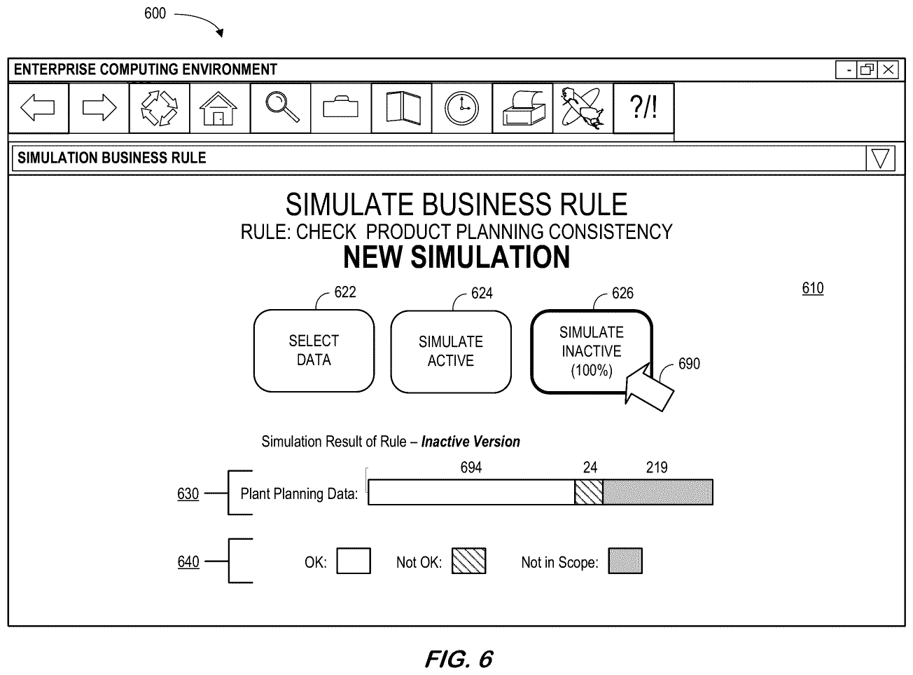

Selection of a “Next” icon 550 may initiate execution of the simulation for the newly defined inactive version of the rule. FIG. 6 is a data validation new inactive simulation display 600 according to some embodiments. As before, the display 600 includes a user interface 610 that lets a user (e.g., a data steward) select data 622, simulate an active rule 624, or simulate an inactive rule 626 (e.g., by selecting those icons with a touchscreen or computer mouse pointer 690). The display 600 also includes a graphical indication of simulation results 630 for the inactive business rule along with a key or legend 640 to help a user interpret the results (e.g., indicating that an electronic record passed a validation rule (“OK”), an indication that an electronic record did not pass a validation rule (“Not OK”), an indication that a validation rule was not applied to an electronic record (“Not in Scope”), etc.). According to some embodiments, a user can select a portion of the simulation results 630 to obtain a “drill down” view of supporting data.

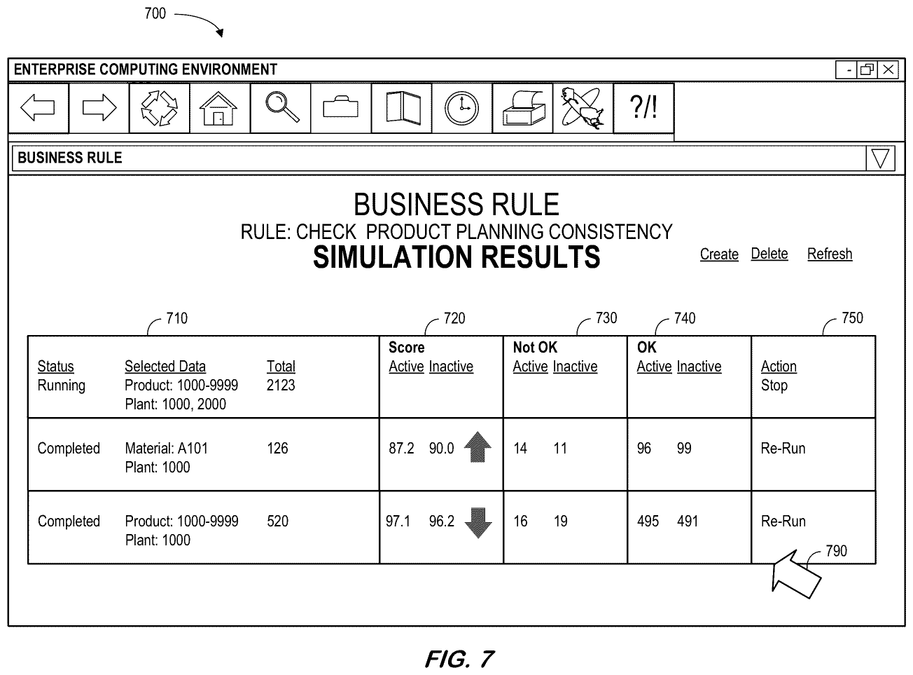

FIG. 7 is a simulation and quality preview display 700 in accordance with some embodiments. The display 700 may provide a dashboard summary of simulation results. In particular, the display 700 includes the current status (e.g., “completed” or “running”), selected data (e.g., the filter conditions), and a total number of records that were evaluated 710. According to some embodiments, the display 700 also includes a date and/or time when the simulation was executed. The display 700 also includes a “Score” for both the active and inactive business rules 720 (e.g., along with an arrow indicating a score change between the active and inactive versions of the business rule). According to some embodiments, the score may be calculated as follows:

$$Score = \frac{OK}{OK + Not OK}$$

The display 700 also includes a number of “Not OK” records for both the active and inactive business rules 730 along with a number of “OK” records for both the active and inactive business rules 740. According to some embodiments, the display 700 provides an action 750 that can be performed by the user (e.g., to stop a currently running simulation, re-run a simulation, etc.). In this way, the display 700 may help a user make informed data validation rule decisions. In some embodiments, simulations will be automatically executed whenever a change happens in the rule, and the system may automatically notify a corresponding quality manager about the quality preview of the change (e.g., via a communication link that is automatically established using a communication address associated with the appropriate quality manager). In some embodiments, the display 700 may include additional columns such as when the simulation was started, who ran the simulation, records that “Not in Scope” (active and inactive), when the simulation was completed, whether a simulation should be automatically executed, information about alerts that should be automatically generated and/or transmitted, etc.

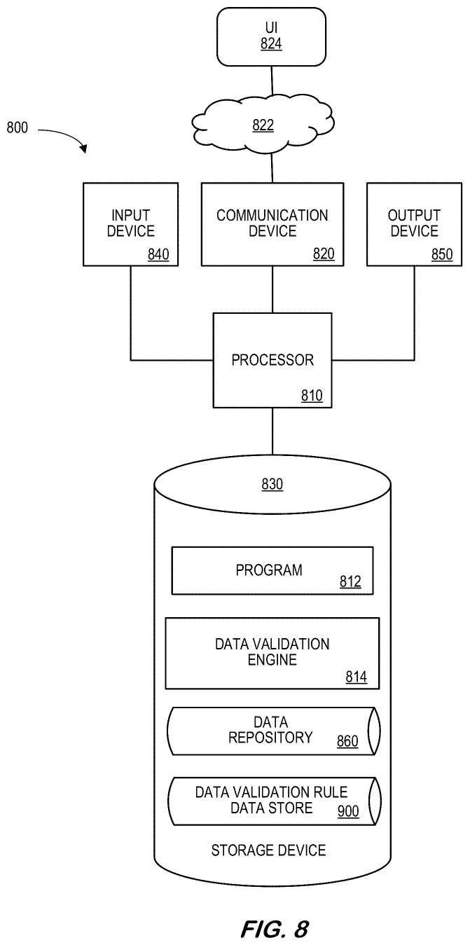

Note that the embodiments described herein may be implemented using any number of different hardware configurations. For example, FIG. 8 is a block diagram of an apparatus or platform 800 that may be, for example, associated with the system 100 of FIG. 1 (and/or any other system described herein). The platform 800 comprises a processor 810, such as one or more commercially available CPUs in the form of one-chip microprocessors, coupled to a communication device 820 configured to communicate via a communication network (not shown in FIG. 8). The communication device 820 may be used to communicate, for example, with one or more remote user platforms or a user interface 824 via a communication network 822. The platform 800 further includes an input device 840 (e.g., a computer mouse and/or keyboard to input data about monitored system or data sources) and an output device 850 (e.g., a computer monitor to render a display, transmit recommendations or alerts (e.g., a data validation alert signal when a score exceeds a threshold amount), and/or create monitoring reports). According to some embodiments, a mobile device and/or PC may be used to exchange data with the platform 800.

The processor 810 also communicates with a storage device 830. The storage device 830 can be implemented as a single database, or the different components of the storage device 830 can be distributed using multiple databases (that is, different deployment data storage options are possible). The storage device 830 may comprise any appropriate data storage device, including combinations of magnetic storage devices (e.g., a hard disk drive), optical storage devices, mobile telephones, and/or semiconductor memory devices. The storage device 830 stores a program 812 and/or data validation engine 814 for controlling the processor 810. The processor 810 performs instructions of the programs 812, 814, and thereby operates in accordance with any of the embodiments described herein. For example, the processor 810 may access an active data validation rule from a data validation rule data store 900. The processor 810 receives an adjustment to the active data validation rule from a user to create an inactive data validation rule. The processor 810 may also receive at least one filter condition defining a subset of the electronic records in a data repository 860. The processor 810 can then automatically simulate execution of the active data validation rule on record characteristics of the subset to obtain an active result and automatically simulate execution of the inactive data validation rule to obtain an inactive result. The processor 810 then displays the active result and the inactive result to the user (e.g., via the user interface 824).

The programs 812, 814 may be stored in a compressed, uncompiled and/or encrypted format. The programs 812, 814 may furthermore include other program elements, such as an operating system, clipboard application, a database management system, and/or device drivers used by the processor 810 to interface with peripheral devices.

As used herein, data may be “received” by or “transmitted” to, for example: (i) the platform 800 from another device; or (ii) a software application or module within the platform 800 from another software application, module, or any other source.

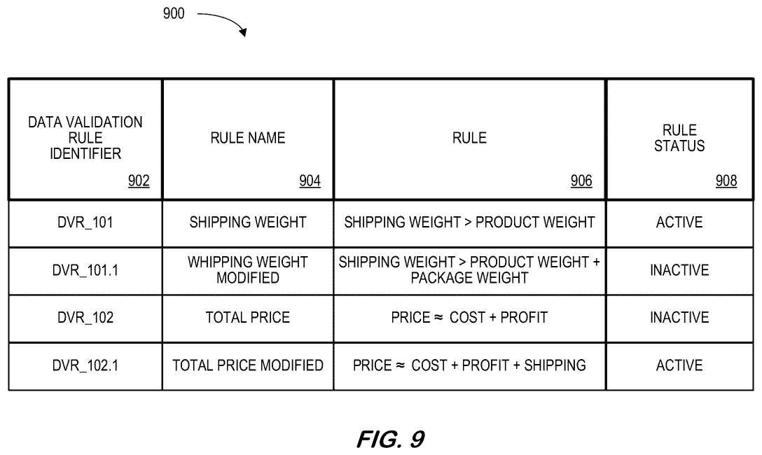

In some embodiments (such as the one shown in FIG. 8), the storage device 830 further stores the data repository 860 and the data validation rule data store 900. An example of a database that may be used in connection with the platform 800 will now be described in detail with respect to FIG. 9. Note that the database described herein is only one example, and additional and/or different data may be stored therein. Moreover, various databases might be split or combined in accordance with any of the embodiments described herein.

Referring to FIG. 9, a table is shown that represents the data validation rule data store 900 that may be stored at the platform 800 according to some embodiments. The table may include, for example, entries identifying business rules in connection with an enterprise data validation environment. The table may also define fields 902, 904, 906, 908 for each of the entries. The fields 902, 904, 906, 908 may, according to some embodiments, specify: a data validation rule identifier 902, a rule name 904, a rule 906, and a rule status 908. The data validation rule data store 900 may be created and updated, for example, when a new rule is defined by a user, filter conditions are defined, simulations are executed to generate results, etc.

The data validation rule identifier 902 might be a unique alphanumeric label or link that is associated with a business data validation rule. The rule name 904 may describe the rule and the rule 906 may define the conditions associated with that rule. The rule status 908 might indicate if that rule is currently active or inactive. For example, rule “DVR_101” named “Shipping Weight” (Shipping Weight>Product Weight) is currently active while rule “DVR_101.1” named “Shipping Weight Modified” (Shipping Weight>Product Weight+Package Weight) is inactive (e.g., it might currently be undergoing evaluation by a data steward). In contrast, “DVR_102.1” named “Total Price Modified” (Price≈Cost+Profit+Shipping) has been made active (and has replaced prior version “DVR_102” after being approved by a data steward).

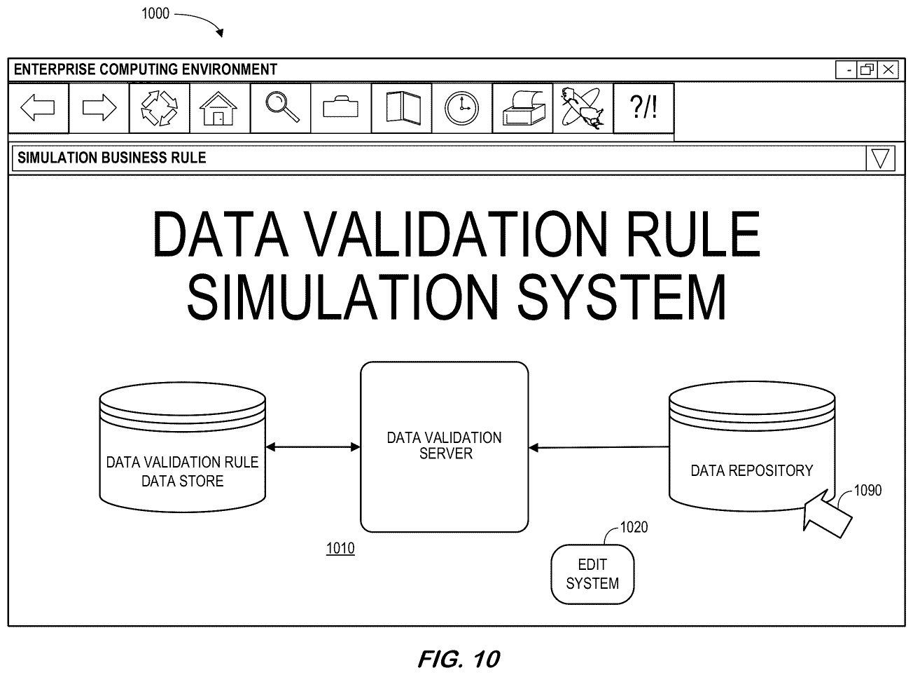

FIG. 10 is a human machine interface display 1000 in accordance with some embodiments. The display 1000 includes a graphical representation 1010 or dashboard that might be used to manage or monitor a data validation rule system. In particular, selection of an element (e.g., via a touchscreen or computer mouse pointer 1090) might result in the display of a popup window that contains mapping or configuration data. The display 1000 may also include a user selectable “Edit System” icon 1020 to request system changes (e.g., to investigate or improve system performance).

Thus, embodiments may provide substantially real-time insight of potential impacts on data quality that are caused by business rule changes. Embodiments may let a data quality manager or steward compare current data quality with future data quality to support informed decisions. In some embodiments, automatic quality preview alerts may be generated whenever changes happen to business rules.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

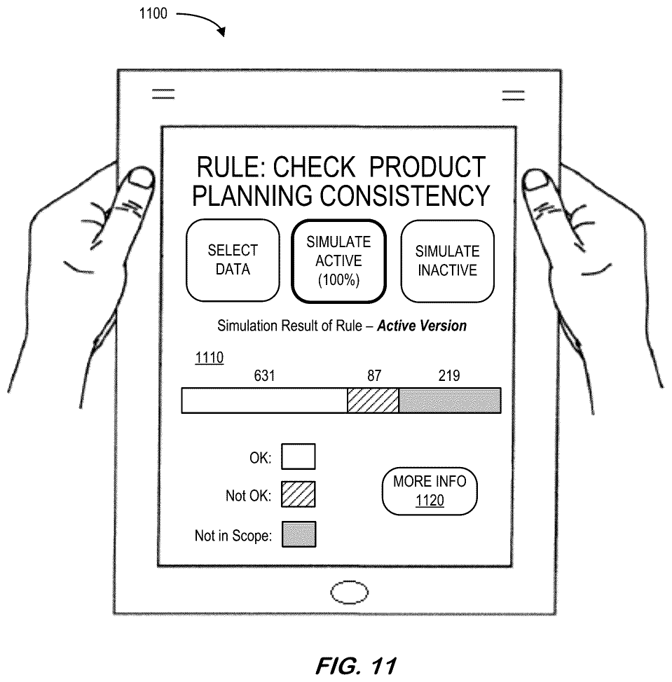

Although specific hardware and data configurations have been described herein, note that any number of other configurations may be provided in accordance with some embodiments of the present invention (e.g., some of the data associated with the databases described herein may be combined or stored in external systems). Moreover, although some embodiments are focused on particular types of business rules, any of the embodiments described herein could be applied to other types of business rules (including relatively complex business rules). Moreover, the displays shown herein are provided only as examples, and any other type of user interface could be implemented. For example, FIG. 11 shows a handheld tablet computer 1100 rendering data validation result display 1110 that may be used to view or adjust active version simulation results and/or to request additional data (e.g., via a “More Info” icon 1120).

In some embodiments, a data steward may manually define data validation rule changes and/or evaluate active and inactive simulation results (e.g., do decide which business rules should be deployed in a production environment). In other embodiments, artificial intelligence and/or machine learning algorithms and predictive models may be used to automate either of these processes (and feedback information may be used to improve the performance of the system).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system to facilitate data validation for an enterprise, comprising:
a data repository containing electronic records, each electronic record including a record identifier and a set of record characteristics;
a data validation rule data store containing at least one active data validation rule; and
a data validation server, coupled to the data repository and the data validation rule data store, including:
a computer processor, and
a memory storage device, coupled to the computer processor, including instructions that, when executed by the computer processor, enable the data validation server to:
(i) access the active data validation rule from the data validation rule data store,
(ii) receive, from a user via a user interface, an adjustment to the active data validation rule to create an inactive data validation rule,
(iii) receive, from the user via the user interface, at least one filter condition defining a subset of the electronic records in the data repository,
(iv) automatically simulate execution of the active data validation rule on record characteristics of the subset of the electronic records in the data repository to obtain an active result,
(v) automatically simulate execution of the inactive data validation rule on record characteristics of the subset of the electronic records in the data repository to obtain an inactive result, and
(vi) arrange for the active result and the inactive result to be displayed to the user.

2. The system of claim 1, wherein the data validation server is further to, responsive to an indication received from the user, replace logic of the active data validation rule with logic of the inactive data validation rule.

3. The system of claim 1, wherein the data validation server is further to receive, from the user via the user interface, a further adjustment to the inactive data validation rule to create a new inactive data validation rule and automatically simulate execution of the new inactive data validation rule on the subset of the electronic records in the data repository to obtain a new inactive result.

4. The system of claim 1, wherein the filter condition includes at least one of: (i) an item identifier condition, (ii) a location condition, (iii) an item type condition, and (iv) a date condition.

5. The system of claim 1, wherein the active result and the inactive result include at least one of: (i) an indication that an electronic record passed a validation rule, (ii) an indication that an electronic record did not pass a validation rule, (iii) an indication that a validation rule was not applied to an electronic record, and (iv) a score calculated for a validation rule.

6. The system of claim 5, wherein the display of the active result and the inactive result is provided graphically via the user interface.

7. The system of claim 6, wherein selection of a portion of the graphic display results in further details about the active result or inactive result being provided to the user.

8. The system of claim 1 wherein the data repository is associated with at least one of: (i) master data management, (ii) master data governance, and (iii) a master data steward.

9. The system of claim 1, wherein the data validation server is further to automatically detect an anomaly in substantially real-time.

10. The system of claim 9, wherein the anomaly is associated with at least one of: (i) a security anomaly, and (ii) a regulatory compliance anomaly.

11. A computer-implemented method to facilitate data validation for an enterprise, comprising:
accessing, by a computer processor of a data validation server, an active data validation rule from a data validation rule data store;
receiving, from a user via a user interface, an adjustment to the active data validation rule to create an inactive data validation rule;
receiving, from the user via the user interface, at least one filter condition defining a subset of electronic records in a data repository, wherein the data repository contains electronic records, each electronic record including a record identifier and a set of record characteristics;
automatically simulating execution of the active data validation rule on record characteristics of the subset of the electronic records in the data repository to obtain an active result;
automatically simulating execution of the inactive data validation rule on record characteristics of the subset of the electronic records in the data repository to obtain an inactive result; and
arranging for the active result and the inactive result to be displayed to the user.

12. The method of claim 11, wherein the data validation server is further to, responsive to an indication received from the user, replace logic of the active data validation rule with logic of the inactive data validation rule.

13. The method of claim 11, wherein the data validation server is further to receive, from the user via the user interface, a further adjustment to the inactive data validation rule to create a new inactive data validation rule and automatically simulate execution of the new inactive data validation rule on the subset of the electronic records in the data repository to obtain a new inactive result.

14. The method of claim 11, wherein the filter condition includes at least one of: (i) an item identifier condition, (ii) a location condition, (iii) an item type condition, and (iv) a date condition.

15. The method of claim 11, wherein the active result and the inactive result include at least one of: (i) an indication that an electronic record passed a validation rule, (ii) an indication that an electronic record did not pass a validation rule, (iii) an indication that a validation rule was not applied to an electronic record, and (iv) a score calculated for a validation rule.

16. The method of claim 15, wherein the display of the active result and the inactive result is provided graphically via the user interface.

17. The method of claim 16, wherein selection of a portion of the graphic display results in further details about the active result or inactive result being provided to the user.

18. The method of claim 11 wherein the data repository is associated with at least one of: (i) master data management, (ii) master data governance, and (iii) a master data steward.

19. A non-transitory, computer readable medium having executable instructions stored therein to perform a method to facilitate data validation for an enterprise, the method comprising:
accessing, by a computer processor of a data validation server, an active data validation rule from a data validation rule data store;
receiving, from a user via a user interface, an adjustment to the active data validation rule to create an inactive data validation rule;
receiving, from the user via the user interface, at least one filter condition defining a subset of electronic records in a data repository, wherein the data repository contains electronic records, each electronic record including a record identifier and a set of record characteristics;
automatically simulating execution of the active data validation rule on record characteristics of the subset of the electronic records in the data repository to obtain an active result;
automatically simulating execution of the inactive data validation rule on record characteristics of the subset of the electronic records in the data repository to obtain an inactive result; and
arranging for the active result and the inactive result to be displayed to the user.

20. The medium of claim 19, wherein the data validation server is further to automatically detect an anomaly in substantially real-time.

21. The medium of claim 20, wherein the anomaly is associated with at least one of: (i) a security anomaly, and (ii) a regulatory compliance anomaly.
